(19) United States
(12) Patent Application Publication
(10) Pub. No.: US 2017/0293163 A1
(43) Pub. Date: Oct. 12, 2017

(54) SHIELD-INTEGRATED EYEWEAR

(71) Applicant: Steven P. Brown, Loyalton, CA (US)

(72) Inventor: Steven P. Brown, Loyalton, CA (US)

(21) Appl. No.: 15/480,555

(22) Filed: Apr. 6, 2017

Related U.S. Application Data
(60) Provisional application No. 62/319,155, filed on Apr. 6, 2016.

(51) Int. Cl. G02C 7/16; G02C 11/00; G02C 1/06

(52) U.S. Cl. CPC G02C 7/16; G02C 1/06; G02C 11/12

(57) ABSTRACT

Shield-integrated eyewear are provided, wherein protective shields are integrated into the eyewear frames. Each shield being incorporated into the optical frame as a unitary solid piece, and providing a curvature adapted to follow and be held flush against an inner curvature of a lens retained within a respective rim of the optical frame. Thereby, the shields can be used as barriers to unwelcome sunlight regardless how many times the lens themselves are replaced.

### CROSS-REFERENCE TO RELATED APPLICATION

This application claims the benefit of priority of U.S. provisional application No. 62/319,155, filed 6 Apr. 2016, the contents of which are herein incorporated by reference.

### BACKGROUND OF THE INVENTION

The present invention relates to eyewear and, more particularly, shield-integrated eyewear, wherein protective shields are molded into the eyewear frames.

Typically, glasses or other prescription eyewear do not block sun interference or direct sunlight from entering the unprotected eye, thus when the sun is at certain levels the eyewear does not afford a barrier to block the damaging sunlight. In these cases, a wearer of such glasses would need to have separate prescription sunglasses, mountable sun shields, or transition lenses, all of which have an additional cost to the eyewear user, and in the case of the separate sunglasses and mountable sun shields can be easily misplaced. Moreover, once the prescription of the user changed or the lens need to be replaced, the cost of the prescription sunglasses and the transition lens would have to be ponied up again. Furthermore, for users of eyewear frames having of a frame that holds a clear or tinted transparent lens, there is no option to protect the eyes from direct sunlight other than to turn away or hold something up to block the sun.

As can be seen, there is a need for shield-integrated eyewear, wherein protective shields are molded into the eyewear frames. With the solid opaque shields incorporated into the frames themselves, an integrated part of the eyewear, a barrier between the eye and sun is always present, preventing sun blindness and reducing eye strain by blocking the sun from the wearer's vision regardless of the changes of or replacement to the lens themselves.

### SUMMARY OF THE INVENTION

In one aspect of the present invention, shield-integrated eyewear includes a frame adapted to be worn across the face of a human user; at least one rim provided by the frame, wherein each rim has at least two opposing side portion, and wherein each portion is adapted to retain a periphery of a lens therebetween; and a shield extending between opposing side portions of each rim.

In another aspect of the present invention, the shield-integrated eyewear includes a frame adapted to be worn across the face of a human user; at least one rim provided by the frame, wherein each rim has at least an upper portion and two opposing side portion, and wherein each portion is adapted to retain a periphery of a lens therebetween; and a solid opaque shield extending between the upper and opposing side portions of each rim, wherein each solid opaque shield has a curvature conforming to a curvature of each respective lens, wherein each solid opaque shield is disposed along each portion just inward of each respective lens, wherein each shield and respective rim are an integrated unitary piece.

These and other features, aspects and advantages of the present invention will become better understood with reference to the following drawings, description and claims.

### BRIEF DESCRIPTION OF THE DRAWINGS

FIG. 1 is a front view of an exemplary embodiment of the present invention;

FIG. 2 is a side elevation view of an exemplary embodiment of the present invention;

FIG. 3 is a front view of an exemplary embodiment of the present invention;

FIG. 4 is a top perspective view of an exemplary embodiment of the present invention; and

FIG. 5 is a top plan view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides shield-integrated eyewear, wherein protective shields are molded into the eyewear frames. Each shield being incorporated into the optical frame as a unitary solid piece, and providing a curvature adapted to follow and be held flush against an inner curvature of a lens retained within a respective rim of the optical frame. Thereby, the shields can be used as barriers to unwelcome sunlight regardless how many times the lens themselves are replaced.

It should be understood by those skilled in the art that the use of directional terms such as upper, lower, upward, downwardly, top, sides and the like are used in relation to the illustrative embodiments as they are depicted in the figures, the upward direction (or upper) being toward the top of the corresponding figures and a downward direction being toward the bottom of the corresponding figure.

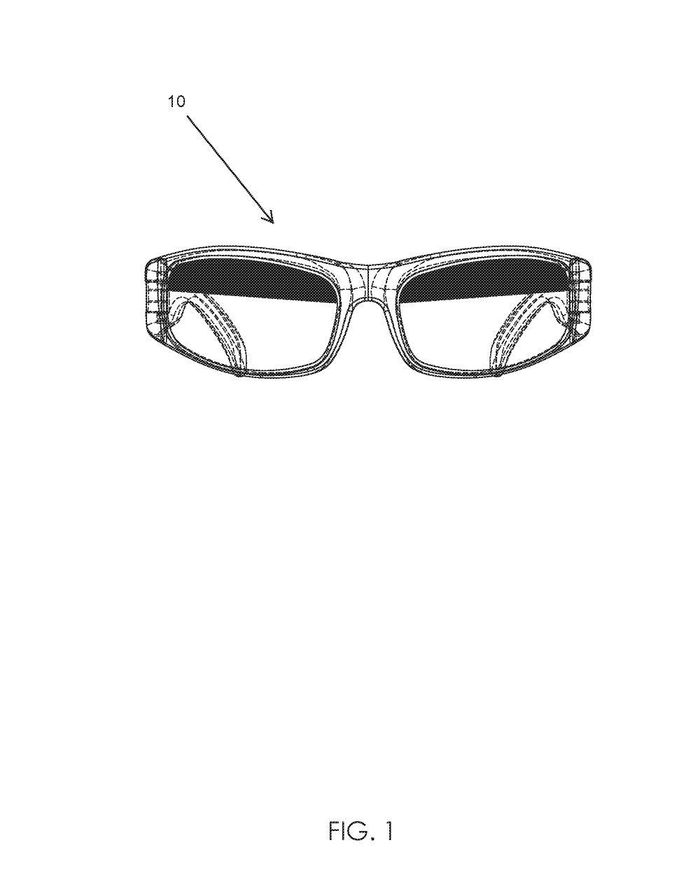

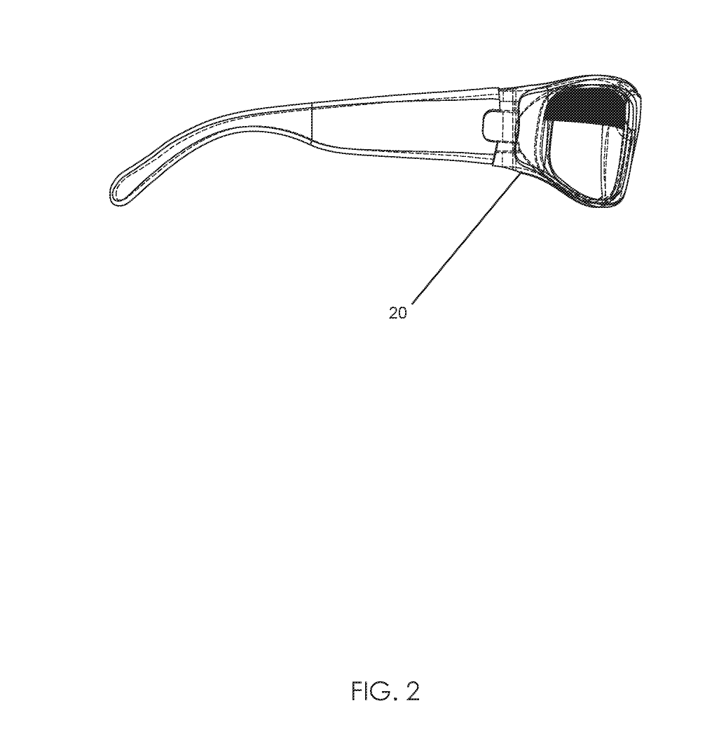

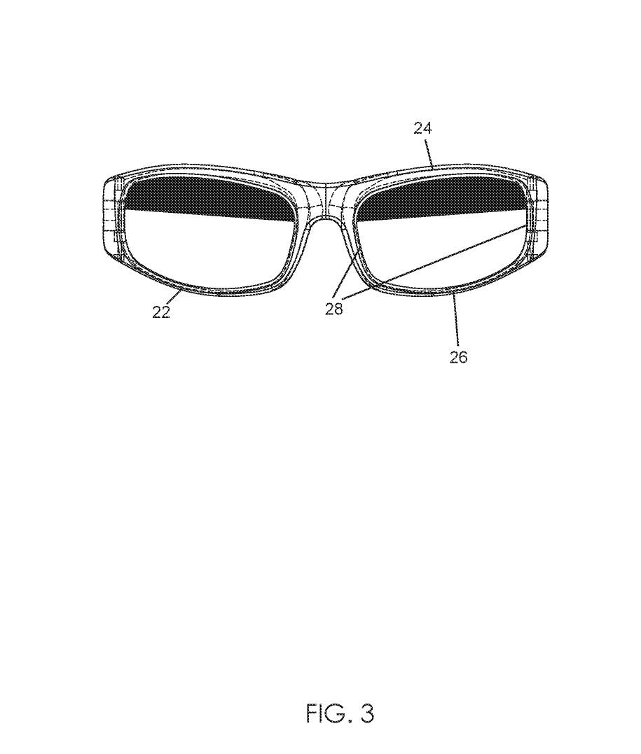

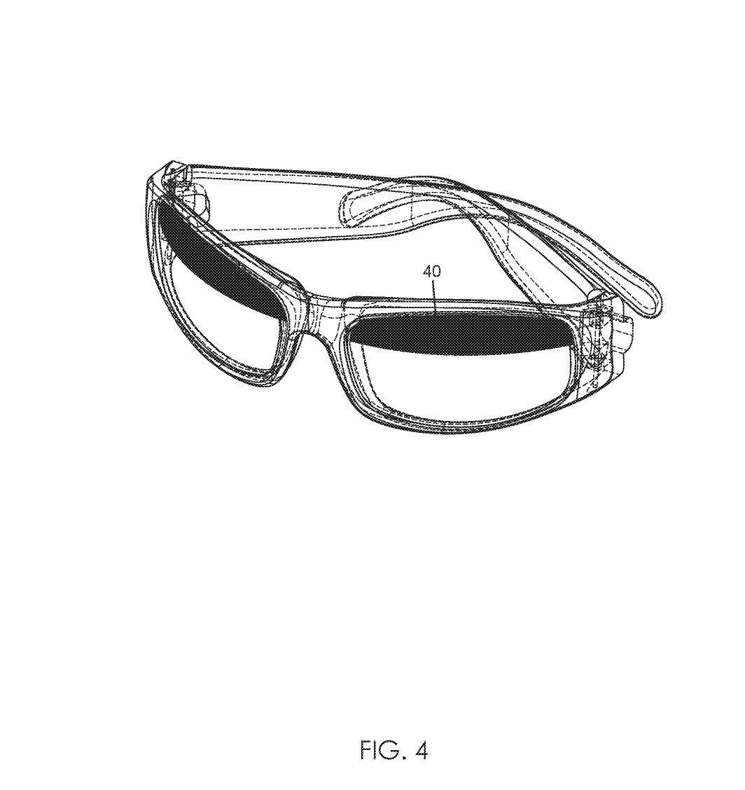

Referring to FIGS. 1 through 5, the present invention provides shield-integrated eyewear 10. The shield-integrated eyewear 10 includes any optical frame 20 adapted to be worn across the face of a human wearer, and having rims 22 for housing at least one lens 30 therein. Each rim 22 may have an upper portion 24, a lower portion 26 and opposing side portions 28 adapted to retain a periphery of the lens 30 therein. Each lens 30 may be prescription or non-prescription lens.

Extending from the side portions 28 and/or the upper portion 24 solid opaque shields 40 may be molded into each rim 22 and thus each optical frame 20. Each shield 40 may be part of a mold that integrates the shield 40 to portions of the rim 22. Each shield 40 may have a curvature adapted accommodate a particular lens 30 shape.

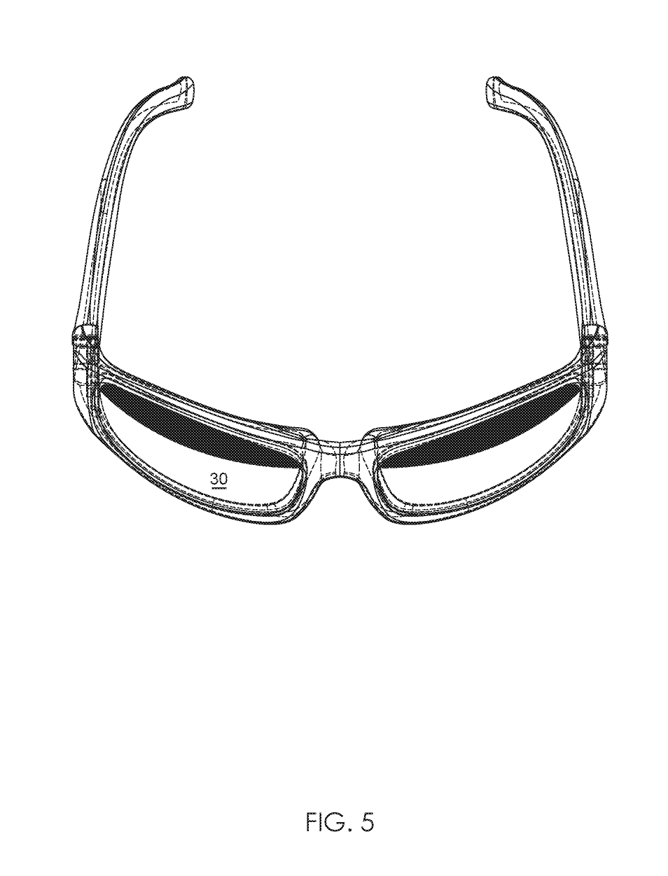

In the mold, through additive printing, or the like, the shields 40 may be incorporated into the optical frame 20 as a complete, unitary solid piece. The solid opaque shield 40 may be applied to all molded or manufactured eyewear optical frames 20. Once the frame 20 is manufactured with the shields 40, the curvature of the shield 40 follow the curve of a lens 30 shape, holding the shield 40 flush against the inner part of the lens 30 once the lens 30 is applied to the frame 20, as illustrated in FIG. 5. The shields 40 may be adapted to act as a barrier between the sun and the wearer's eye, and so may be disposed along an upper portion of the rim 22.

A mold would be designed and created which incorporates the solid opaque shields 40 with each design of desired eyewear optical frames 20.

A method of using the present invention may include the following. The shield-integrated eyewear 10 disclosed above may be provided. A user would wear the shield-integrated eyewear 10 in a normal fashion as one would wear any eyewear. When the sun is at certain levels one would simply align the shield with one's eyes and the sun, blocking out the sunlight. This is achieved by tilting one's head either up or down using the shield 40 as a tool to block the sunlight. The shield 40 acts as a barrier between the eyes and sun to shade the eyes from sun glare.

It should be understood, of course, that the foregoing relates to exemplary embodiments of the invention and that modifications may be made without departing from the spirit and scope of the present invention.

I claim:

1. An eyewear with integrated sun shield, comprising:
a frame adapted to be worn across the face of a human user;
at least one rim provided by the frame, wherein each rim has at least two opposing side portion, and wherein each portion is adapted to retain a periphery of a lens therebetween; and
a shield extending between opposing side portions of each rim.

2. The eyewear of claim 1, wherein each shield is solid opaque.

3. The eyewear of claim 1, wherein each shield has a curvature conforming to a curvature of each respective lens.

4. The eyewear of claim 1, wherein each shield is disposed along each opposing side portion just inward of each respective lens.

5. The eyewear of claim 1, wherein each shield and respective rim are a unitary piece.

6. The eyewear of claim 1, wherein each shield and respective rim integrated as a unitary piece.

7. The eyewear of claim 1, wherein each shield is adapted to block sunlight.

8. The eyewear of claim 1, wherein each rim further includes an upper portion also adapted to retain a periphery of the respective lens, and wherein the respective shield extends therefrom.

9. An eyewear with integrated sun shield, comprising:
a frame adapted to be worn across the face of a human user;
at least one rim provided by the frame, wherein each rim has at least an upper portion and two opposing side portion, and wherein each portion is adapted to retain a periphery of a lens therebetween; and
a solid opaque shield extending between the upper and opposing side portions of each rim, wherein each solid opaque shield has a curvature conforming to a curvature of each respective lens, wherein each solid opaque shield is disposed along each portion just inward of each respective lens,
wherein each shield and respective rim are an integrated unitary piece.

10. The eyewear of claim 9, wherein each shield is adapted to block sunlight.
